(19) United States
(12) Patent Application Publication
(10) Pub. No.: US 2003/0152316 A1
(43) Pub. Date: Aug. 14, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/167,291

(22) Filed: Jun. 10, 2002

(30) Foreign Application Priority Data
Feb. 8, 2002 (TW) 91201728

(51) Int. Cl. G02B 6/35; G02B 6/34

(52) U.S. Cl. 385/20; 385/16; 385/36

(57) ABSTRACT

An optical switch for switching multiple beams from a plurality of input optical fibers among a plurality of output optical fibers includes a mounting frame (26), an input optical device (21) for emitting light signals and an output optical device (22) for receiving the emitted light signals out of the optical switch. A parallel first and second prism holders (251), (252) are movably mounted between the input optical device and the output optical device. A first prism array (23) including a plurality of first prisms is attached to the first prism holder and a second prism array (24) is attached to the second prism holder. A driving device assembly (27), which comprises a pair of driving devices (271) and two pairs of connecting poles (272), and drives the first and second prism holders to slidably move relative to the mounting frame and each other. Thus, a different first prism of the first prism array is paired with a different selected second prism of the second prism array for each position of each prism holder forming between the input and output fibers.

### BACKGROUND OF THE INVENTION

1. Field of the Invention

This invention relates generally to an optical switch, and more particularly to an optical switch having two movable arrays of prisms which act together to switch multiple beams from a plurality of input fibers among a plurality of output fibers.

2. Description of the Related Art

In conventional optical switches, high insertion losses and optical directivity are problems. Referring to FIG. 6, U.S. Pat. No. 5,420,946 discloses an optical coupling device having one input fiber and a plurality of output fibers. A reflector assembly can be rotated to reflect an optical signal from the input fiber to any one of the pluralities of output fibers, thus effecting a switching action. However, this particular optical switch comprises an excessive number of parts. Operation of this switch requires an excessive angular tolerance and distance tolerance, which in turn results in high insertion losses.

In view of the above, it is desired to provide an optical switch which has relatively few parts, which accomplishes optical path switching with low insertion losses and a simple operating mechanism, and which can be produced at low cost.

An example of an optical switch is disclosed in co-pending application, U.S. Ser. No. 10/098,325, filed on Mar. 15, 2002 by the same inventor as this application. It is hereby incorporated by reference.

### SUMMARY OF THE INVENTION

Therefore, an object of the present invention is to provide an optical switch which has low insertion loss.

Another object of the present invention is to provide an optical switch which can be easily and quickly assembled.

A further object of the present invention is to provide an optical switch which is inexpensive.

To achieve the above objects, an optical switch in accordance with the present invention is used for switching multiple beams from a plurality of input optical fibers among a plurality of output optical fibers includes a mounting frame, an input optical device for emitting light signals and an output optical device for receiving the emitted light signals out of the optical switch. A parallel first and second prism holders are movably mounted between the input optical device and the output optical device. A first prism array including a plurality of first prisms is attached to the first prism holder and a second prism array is attached to the second prism holder. A driving device assembly, which comprises a pair of driving devices and two pairs of connecting poles, and drives the first and second prism holders to slidably move relative to the mounting frame and to each other. Thus, a different first prism of the first prism array is paired with a different selected second prism of the second prism array for each position of each prism holder forming between the input and output fibers.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a perspective view of an optical switch in accordance with the present invention;

FIG. 2 is a cross section view taken along line II-II of FIG. 1;

FIG. 3 is another cross section view taken along line III-III of FIG. 1;

FIGS. 4 and 5 are light path schematic views of the optical switch of FIG. 1; and

FIG. 6 is a perspective view of an optical switch in accordance with the prior art.

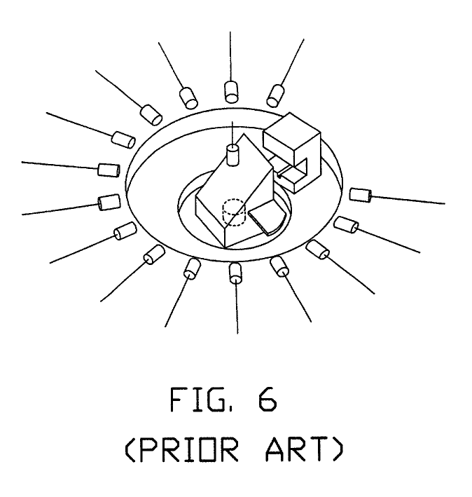

### DETAILED DESCRIPTION OF THE PREFERRED EMBODIMENT

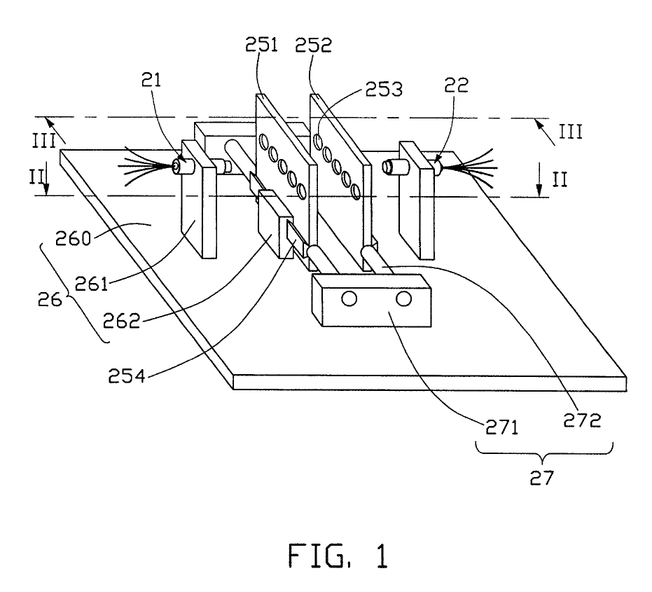

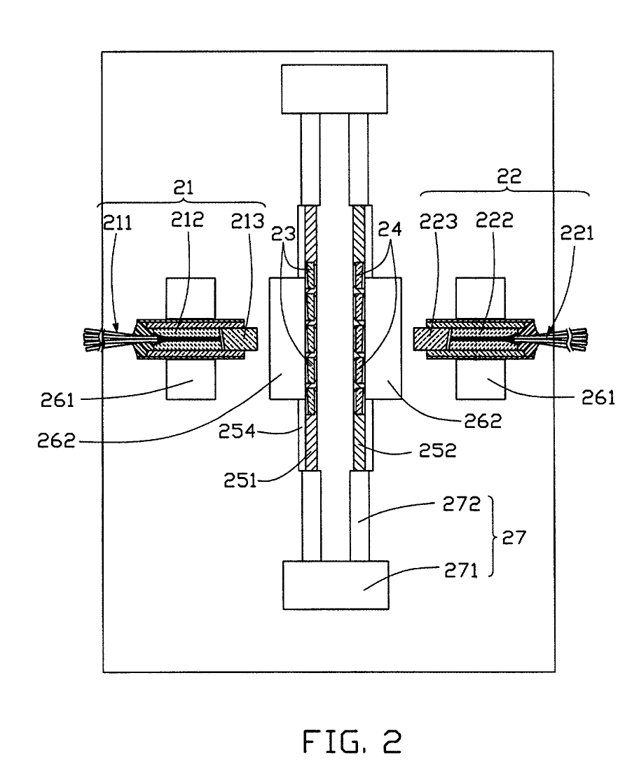

Referring to FIGS. 1 and 2, an optical switch of the present invention comprises a mounting frame 26, an input device 21, an output device 22, an array of first prisms 23, an array of second prisms 24, a first prism holder 251, a second prism holder 252, and a driving device assembly 27.

Referring to FIG. 2, the input device 21 includes a plurality of input optical fibers 211, an input ferrule 212, and an input collimating prism 213. The output device 22 includes a plurality of output optical fibers 221, an output ferrule 222, and a collimating prism 223. Both the input and output ferrules 212, 222 are typically cylindrical in shape and each defines a channel (not labeled) therethrough along a longitudinal axis thereof.

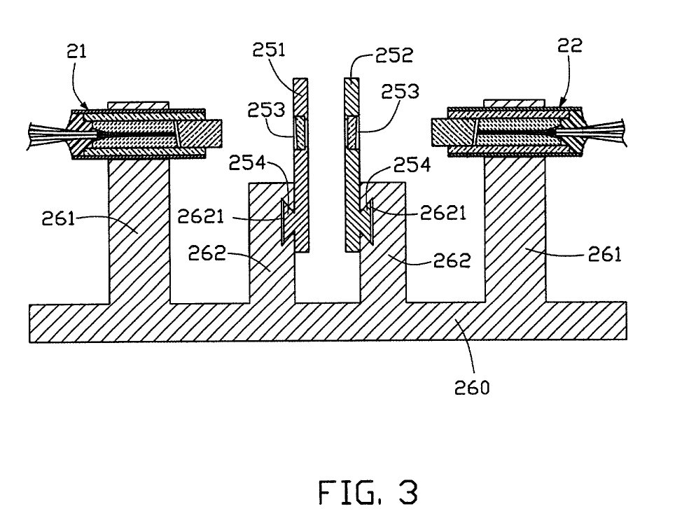

The array of first prisms 23, best shown in FIG. 3, is mounted in the first prism holder 251 and the array of second prisms 24 is mounted in the second prism holder 252. Each first prism 23 has a different geometry and each second prism 24 has a different geometry Thus a beam of light passing through the different first prisms 23 or through the different second prisms 24 is directed along a different path. In particular, a light beam directed through a pair of prisms comprising one first prism 23 and one second prism 24 is bent along a unique path, depending on which of the first prisms 23 is paired with which of the second prisms 24.

Referring to FIGS. 1 and 2, the first prism holder 251 and the second prism holder 252 can each be of any shape but are preferably rectangular. A plurality of prism holes 253 is defined through an upper portion of the first prism holder 251 and through an upper portion of the second prism holder 252, arranged in a line. A mounting rail 254 is formed on a side of a lower portion of each of the first and second prism holders 251, 252. A cross section of the mounting rail 254 is preferably trapezoidal in shape, with a longer side of the trapezoid projecting away from the corresponding prism holder 251, 252.

The mounting frame 26 comprises a mounting frame 260, two first mounting supports 261 and two second mounting supports 262. Said first mounting supports 261 project upwardly from the mounting frame 260 parallel to one another. A mounting hole (not labeled) is defined through an upper portion of each first mounting support 261, aligned with one another. The two second mounting supports 262 also project upwardly from the mounting frame 260, are parallel with one another, and are formed between the two first mounting supports 261. The inner surface of each second mounting support 262 defines a guide notch 2621, a cross section of each guide notch being dimensioned to slidingly accommodate a respective mounting rail 254 therein.

The driving device assembly 27 comprises two driving devices 271 and two connecting poles 272. Each connecting pole 272 is engaged between a corresponding driving device 271 and a corresponding side of either the first prism holder 251 or the second prism holder 252. The first prism holder 251 and the second prism holder 252 each slide along a corresponding second mounting support 262, the mounting rail 254 slidingly engaging with a corresponding guide notch 2621.

Referring to FIGS. 1-3, in assembly, an outer sheath (not labeled) of each of the plurality of input optical fibers 211 and output optical fibers 221 is stripped off and cores (not labeled) of the input optical fibers 211 are inserted into and held within the channel (not labeled) of the input ferrule 212, and cores (not labeled) of the output optical fibers 221 are inserted into and held within the channel (not labeled) of the output ferrule 222. The input collimating prism 213 is attached at a front side of the input ferrule 212 and the input device 21 is assembled into the mounting hole (not labeled) of a corresponding first mounting support 261. Similarly, the output collimating prism 223 is assembled at a front side of the output ferrule 222 and the output device 22 is assembled into the mounting hole of a corresponding opposite first mounting support 261, aligned with and facing a front end of the input device 21. The first prism holder 251, with corresponding first prisms 23 mounted in corresponding prism holes 253, is assembled to a second mounting support 262 nearest the input device 21, with the mounting rail 254 of the first prism holder 251 slidingly engaging with the guide notch 2621 of the second mounting support 262. Similarly, the second prism holder 252, with corresponding second prisms 24 mounted in corresponding prism holes 253, is assembled to a second mounting support 262 nearest the output device 22, with the mounting rail 254 of the second prism holder 252 slidingly engaging with the guide notch 2621 of the second mounting support 262. Driving devices 271 are attached to the mounting frame 260 at either end of the prism holders 251, 252, and connecting poles 272 are connected between corresponding driving devices 271 and either a corresponding end of the first prism holder 251 or a corresponding end of the second prism holder 252.

Referring to FIGS. 1-2, in operation, the driving devices 271 coordinate their operations on corresponding connecting poles 272 to independently move the first and the second prism holders 251, 252 back and forth along the corresponding guide notches 2621. Thus different combinations of first prisms 23 and second prisms 24 align between the input device 21 and the output device 22.

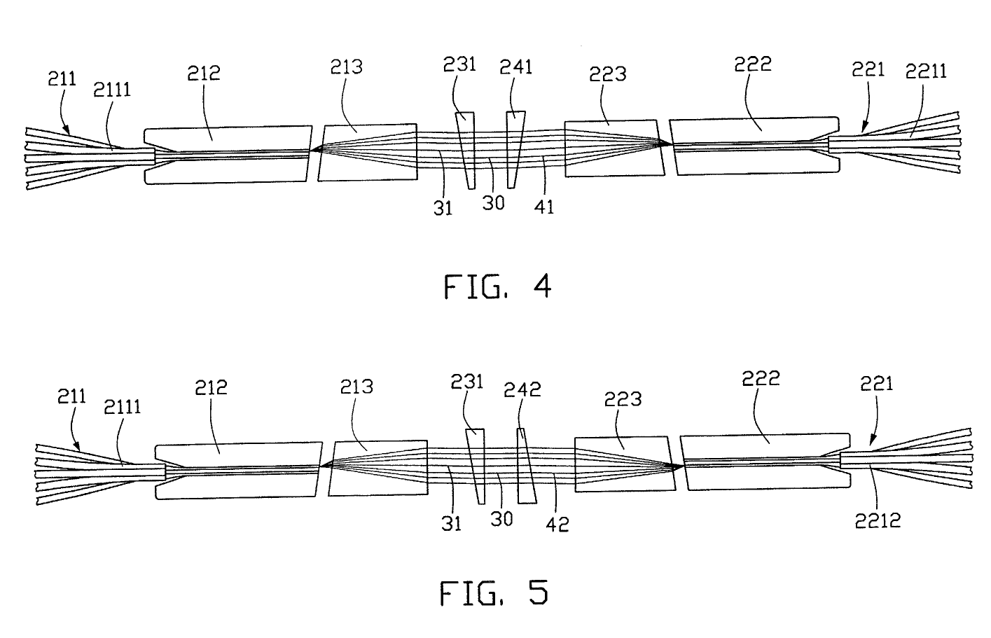

FIGS. 4-5 schematically illustrate the switching action of the optical switch. In particular, referring to FIG. 4, a beam of light is shown being emitted from an input optical fiber 2111 and passing consecutively through the input collimating prism 213, an individual first prism 231, an individual second prism 241, the output collimating prism 223, to an individual output fiber 2211. Concentrating on the individual ray lines, the light beam is expanded and collimated by the input collimating prism 213, then travels as parallel rays 31, 30, 41 before, between and after passing through prisms 231, 241. The parallel rays are then focused down by the output collimating prism 223 to be directed to the individual output fiber 2211. The resulting action of the two prisms 231, 241 determines the focal point of the collimated beam on the output fiber 2211.

Note that in FIG. 5 the second prism 241 is replaced by a different second prism 242 of the array of second prisms 24. The action of the second prism 242 results in a shift of the light beam as shown by parallel rays 42 such that the beam focal point following beam passage through the output collimating prism 223 is on a different output fiber 2212. Substitution of the second prism 242 for the second prism 241 thus switches the light signal to a new output fiber 221. A similar switching process occurs for each change of prisms 23, 24, for each input fiber 211 and each output fiber 221.

Note that the replacement of the second prism 241 with the second prism 242 is performed by the driving device assembly 27 moving the second prism holder 252 until the second prism 242 aligns with the first prism 231, the input device 21, and the output device 22. In a similar way, the driving device assembly 27 drives the first and second prism holders 251, 252 to position selected pairs of prisms 23, 24 between the input device 21 and the output device 22. Each different pair of prisms 23, 24 results in the beam from a given input optical fiber 211 being focused on a different output optical fiber 221. Thus optical switching is accomplished by the driving device assembly 27.

It should be understood that various changes and modifications to the presently preferred embodiment described herein will be apparent to those skilled in the art. Such changes and modifications may be made without departing from the spirit and scope of the present invention and without diminishing the present invention's advantages. Thus, it is intended that such changes and modifications be covered by the appended claims.

1. An optical switch device comprising:
an optical input device being adapted to convey optical signals into the optical switch;
an optical output device being adapted to convey the optical signals out of the optical switch, the optical output device being aligning with the optical input device; and
a first prism array mounted in a first prism holder and a second prism array mounted in a second prism holder, the first prism array including a plurality of prisms, the holders being moveably held in parallel to one another, the optical input device and the optical output device, each first prism of the first prism array having a different geometry and each second prism of the second prism array having a different geometry;
wherein when one of the first prisms is aligned with a selected one of the second prism, and both are aligned with the optical input device and the optical output device, a light beam from the optical input device directed through the paired prisms is bent along a unique path to the optical output device.

2. The optical switch as described in claim 1, further comprising a mounting frame.

3. The optical switch as described in claim 2, further comprising a pair of first mounting supports projecting upwardly from the mounting frame, the optical input device and the optical output device each attaching to a different one of the first mounting supports.

4. The optical switch as described in claim 1, wherein a plurality of prism holes is defined through an upper portion of the first prism holder and through an upper portion of the second prism holder, each prism hole being for holding one first prism and one second prism, respectively.

5. The optical switch as described in claim 3, wherein a mounting rail being formed on a lower portion of each of the first and second prism holders.

6. The optical switch as described in claim 5, further comprising a pair of second mounting supports projecting upwardly from on the mounting frame, a guide notch being formed on an inner face of each of said second mounting supports, a cross section of each guide notch being dimensioned to slidingly accommodate a respective mounting rail therein.

7. The optical switch as described in claim 1, further comprising a pair of driving device assembly for driving the prism holders to move relative to one another.

8. The optical switch as described in claim 7, wherein the driving device assembly has a pair of driving devices and two pairs of connecting poles.

9. An optical switch adapted to switch multiple light beams coming from a plurality of input optical fibers between a plurality of output fibers, wherein the pair of second mounting supports is between the pair of first mounting supports and are parallel to one another comprising:
a mounting frame including a pair of mounting supports and a pair of second mounting supports;
an input optical device mounted on one of the first mounting supports and terminating the plurality of input optical fibers, including an input ferrule and a output collimating prism;
an output optical device mounted on the other of the first mounting supports and terminating the plurality of output optical fibers, including an output ferrule and an output collimating prism;
a first prism holder and a second prism holder being respectively slidably engaged with a corresponding second mounting support;
a first prism array having a plurality of first prisms mounted in the first prism holder and a second prism array having a corresponding plurality of second prisms mounted in the second prism holder, each first prism having a different geometry and each second prism having a different geometry; and
a driving device assembly for driving the first prism holder and the second prism holder to slidably move relative to on the second mounting supports;
wherein when a first prism in the first prism array is aligned with a selected second prism in the second prism array and with the input and output optical devices, a light beam from the input optical device directed through the paired prisms is bent along a unique path to arrive at the output optical device.

10. The optical switch as described in claim 9, wherein the prisms of each prism array are arranged in a line.

11. The optical switch as described in claim 9, wherein the driving device assembly drives the prism holder to move horizontally relative to the second mounting supports.

12. The optical switch as described in claim 9, wherein the different combinations of first prisms and second prisms align between the input device and the output device.

13. The optical switch as described in claim 9, wherein the driving device assembly comprising a pair of driving devices and two pairs of connecting poles, and the driving devices move the corresponding connecting poles to independently move the first and the second prism holders.

14. An optical switch device comprising:
an optical input device with a plurality of optical input fibers arranged in a compact manner;
an optical output device with a plurality of optical output fibers arranged in another compact manner;
a first light deflection device including a plurality of first light deflection elements corresponding to said input fibers;
a second light deflection device including a plurality of second light deflection elements corresponding to said output fibers;
said input device and said output device being stationary while said first light deflection device and said second light deflection device being moveable to be selectively aligned with the corresponding input fibers and output fibers; wherein
said first deflection elements are configured to capture light from the different selective input fibers in a one-to-one state at one time, and further have said light deflected to travel in a common path, while said second deflection elements are configured to capture light from said common path and further have said light deflected to target the different selective output fibers in the one-to-one state at one time.

15. The device as described in claim 14, wherein said first light deflection device moves linearly.

16. The device as described in claim 14, wherein said second light deflection device moves linearly.

17. The device as described in claim 14, wherein both said input device and said output device are arranged radially compact.

18. A method of transmitting light from one of N input fibers to one of N output fibers (N is an integral), comprising steps of:
providing stationary N input fibers;
providing stationary N output fibers;
providing a moveable input light deflection device with N input light deflection elements thereof corresponding to said N input fibers, respectively; and
providing a moveable output light deflection device with N output light deflection elements thereof corresponding to said N output fibers, respectively; wherein
when light from a specific one of said input fibers is designated to be outputted via a specific one of said output fibers, moving said input light deflection device to have the corresponding input light deflection element aligned with said specific one of said input fibers, and moving said output light deflection device to have the corresponding output light deflection element aligned with said specific one of said output fibers.

19. The method as described in claim 17, wherein said input light deflection device is moved linearly.

20. The method as described in claim 17, wherein said output light deflection device is moved linearly.
